(19) United States
(12) Patent Application Publication
(10) Pub. No.: US 2010/0250348 A1
(43) Pub. Date: Sep. 30, 2010

(54) PLATFORM OR USER SENSITIVE ADVERTISING

(75) Inventor: Patricia L. Dunbar, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/411,153

(22) Filed: Mar. 25, 2009

(51) Int. Cl. G06Q 30/00; H04M 3/42; H04N 7/025

(52) U.S. Cl. 705/14.4; 455/414.1; 725/35

(57) ABSTRACT

In accordance with one or more aspects of the platform or user sensitive advertising, appropriate ads to be served for playback via a platform are identified based at least in part on one or more platform rules for the platform. The timing of when the appropriate ads are to be served can also be based at least in part on the one or more platform rules for the platform. In accordance with other aspects of the platform or user sensitive advertising, a next ad of an ad campaign that is to be presented to a user is identified based at least in part on one or more ads in the ad campaign that have previously been played back via one or more platforms regardless of which of the one or more platforms were being used by the user while playing back the one or more ads.

### BACKGROUND

As computing technology has advanced, digital content has become increasingly available on a variety of different types of devices. For example, movies and other television programs are available for playback on computers, game consoles, wireless phones, and so forth. This digital content can be made available to devices in a variety of different manners, such as broadcasting content, streaming content, distributing content on other media, and so forth. While this variety of different types of devices can be beneficial for the user, it is not without its problems. One such problem is that advertising is frequently played back along with the digital content. As different advertising is oftentimes desired for different types of devices, it can be difficult and cumbersome for the advertiser and/or content owner to specify how advertising is to be played back for digital content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, one or more platform rules identifying one or more restrictions on serving ads to each of multiple different platforms is received. Information describing both an ad campaign and content to which the ad campaign corresponds is also received. A current platform via which content is currently being played back is identified, and an appropriate ad from the ad campaign to be served to the current platform is identified. This identifying of the appropriate ad is based at least in part on the ad campaign and the one or more platform rules for the current platform.

In accordance with one or more aspects, a time that an ad in an ad campaign is to be served to a device is determined. A user of the device is identified, and a next ad in the ad campaign that is to be presented to the user is identified. This next ad is identified based at least in part on one or more ads in the ad campaign that have previously been played back by one or more devices regardless of which of the one or more devices were being used by the user while playing back the one or more ads. The identified ad is also served to the device.

### BRIEF DESCRIPTION OF THE DRAWINGS

The same numbers are used throughout the drawings to reference like features.

FIG. 1 illustrates an example system implementing the platform or user sensitive advertising in accordance with one or more embodiments.

FIG. 2 illustrates an example user interface that can be displayed to a user to allow the user to select whether user tracking module will track the user across multiple devices in accordance with one or more embodiments.

FIG. 3 is a flowchart illustrating an example process for identifying an ad to serve to a device in accordance with one or more embodiments.

FIG. 4 is a flowchart illustrating another example process for identifying an ad to serve to a device in accordance with one or more embodiments.

FIG. 5 illustrates an example computing device that can be configured to implement the platform or user sensitive advertising in accordance with one or more embodiments.

### DETAILED DESCRIPTION

Platform or user sensitive advertising is discussed herein. A platform specific ad decision service is configured to serve ads to different types of platforms including different types of devices. The serving of a particular ad to a particular platform is dependent on one or more ad campaign, content information identifying particular ads for particular content, and a set of platform rules associated with the particular platform on which the particular ad is being served. The platform specific ad decision service automatically serves the correct ad in a correct manner based on the ad campaign and content information as well as the set of platform rules. Additionally, the platform specific ad decision service can optionally track users across different platforms, allowing a particular sequence of ads to be presented to the user across multiple different platforms. This tracking can be performed, for example, after receiving the user's permission to do so.

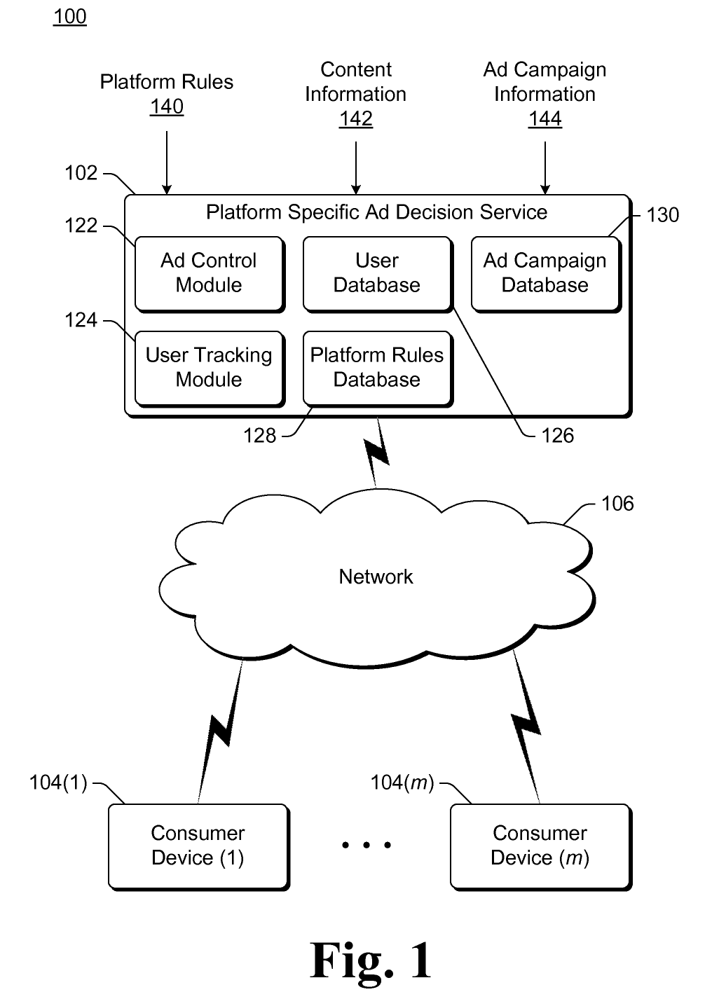

FIG. 1 illustrates an example system 100 implementing the platform or user sensitive advertising in accordance with one or more embodiments. System 100 includes a platform specific ad decision service (PSADS) 102 that can communicate with one or more (m) consumer devices 104(1 . . . m) via a network 106. Network 106 can be a variety of different networks, including the Internet, a local area network (LAN), a public telephone network, a cellular or other wireless telephone network, an intranet, other public and/or proprietary networks, combinations thereof, and so forth.

Consumer devices 104 can each be a variety of different devices capable of displaying or otherwise presenting advertisements (ads). For example, consumer device 104 can be a desktop computer, a mobile station, an entertainment appliance, a set-top box communicatively coupled to a display device, a cellular or other wireless phone, a game console, an automotive computer, and so forth. Thus, consumer device 104 may range from a full resource device with substantial memory and processor resources (e.g., personal computers, game consoles) to a low-resource device with limited memory and/or processing resources (e.g., traditional set-top boxes, hand-held game consoles).

Different types of consumer devices 104 (e.g., desktop computers, set-top boxes coupled to a display device, wireless phones, and so forth) are typically controlled by different operating systems (and/or control applications). Different device and operating system combinations (or device and control application combinations) can be referred to as different platforms. For example, two devices having the same hardware components but running different operating systems can be two different platforms. Additionally, within a group of devices of the same type running the same operating systems, devices using or supporting different types of communication channels between the device and service 102 can be different platforms. The different types of communication channels can include use of different techniques or protocols for communicating signals, different restrictions on the rate or amount of data communicated, and so forth. For example, wireless phones distributed by one company can use one type of communication channel, while wireless phones distributed by another company can use a different type of communication channel. Thus, the wireless phones distributed by these two different companies are two different platforms.

Platform specific ad decision service 102 is implemented by one or more computing devices. Each of these different computing devices can be a variety of different types of devices analogous to consumer devices 104 discussed above.

Generally, platform specific ad decision service 102 identifies an appropriate one or more ads to be served to each of consumer devices 104 at appropriate times. As discussed in more detail below, the appropriate one or more ads and appropriate times are dependent on platform rules associated with one or more of consumer devices 104, the particular content being played back at the consumer devices 104, and the particular ad campaigns available to service 102. As the appropriate one or more ads and appropriate times are dependent on the platform rules, the advertising presented to users of consumer devices 104 is also referred to as being sensitive to the platforms of consumer devices 104.

Additionally, as discussed in more detail below, a user can be tracked across multiple consumer devices 104 and ads from an ad campaign served to those devices 104 based on one or more previous ads from the ad campaign regardless of the device or devices to which those previous ads were served. Accordingly, the advertising presented to users of consumer devices 104 is also referred to as being sensitive to the users of consumer devices 104.

References are made herein to playing back content. It is to be appreciated that content that is played back by a consumer device 104 can be obtained by the consumer device 104 in a variety of different manners. For example, the content can be broadcast to the consumer device 104 and played back by the device 104 as the content is received by device 104, the content can be streamed to the consumer device and played back by the device 104 as the content is received by device 104, the content can be recorded by consumer device 104 and played back at a later time, the content can be played back from a tangible distribution media (e.g., a DVD), and so forth.

It is also to be appreciated that the one or more ads that are service to each of consumer devices 104 at appropriate times can be, but need not be, the same ads as would have originally been displayed during playback of the content. For example, a particular ad may be broadcast or streamed with content for display at a particular time, but consumer device 104 can replace that particular ad with a different ad received from platform specific ad decision service 102. By way of another example, a particular ad may have been broadcast or streamed with content and recorded by consumer device 104 along with the content, and then consumer device 104 can play back a different ad from platform specific ad decision service 102 when the content is played back from the recording.

Platform specific ad decision service 102 can include at least an ad control module 122, a user tracking module 124, a user database 126, a platform rules database 128, and an ad campaign database 130. It is to be appreciated that service 102 can also optionally include one or more additional modules or components (not shown). Ad control module 122 controls the serving of ads to consumer devices 104, which is the advertising that is presented to the users of consumer devices 104. Ad control module 122 determines when an ad is to be served to a consumer device 104 as well as what ad is to be served to a consumer device 104 based on various criteria as discussed in more detail below. Serving of an ad to a consumer device 104 refers to sending or transmitting the ad to the consumer device 104 for playback by the consumer device 104.

User tracking module 124 tracks particular users across different devices 104 (and/or across different platforms), and stores information in user database 126 to facilitate this tracking. By tracking users, ad control module 122 is able to serve ads in ad campaigns to the user without regard for which of the devices 104 previous ads in the ad campaign were served, as discussed in more detail below. This can result in a more user-friendly and coherent ad campaign being presented to the user because service 102 can track which ads in the ad campaign have already been presented to the user.

User tracking module 124 can track users in a variety of different explicit and/or implicit manners. In one or more embodiments, a user is explicitly tracked by a user of consumer devices 104 requesting or instructing the consumer devices 104 to sign in or log in to service 102, thereby providing an identifier of the user to service 102. As part of the sign in or log in process, the user identifies himself or herself, and this identification is independent of which consumer device 104 he or she is using. Accordingly, service 102 can readily track the user across multiple consumer devices 104.

In other embodiments, user tracking module 124 can automatically identify the user across different devices without the user needing to sign in or log in to service 102. This automatic identification is also referred to as implicit tracking. For example, user tracking module 124 can automatically identify a user based on e-mail messages, instant messages, or other types of communications sent by the user. An identifier of the user (such as an e-mail address) can be identified by module 124 and an identifier of the consumer device 104 from which the communication was sent can be maintained. For example, the MAC (Media Access Control) addresses of different devices 104 from which the user sends communications can be identified by module 124 and stored in user database 126. Tracking module 124 can track users in a variety of different well-known manners, and this tracking will not be discussed further herein except as it pertains to the platform or user sensitive advertising discussed herein.

User database 126 can also maintain information regarding which ads in an ad campaign have been presented to a user of consumer devices 104. This information can identify, for example, particular ads in an ad sequence that have been presented to the user, a count of how many times a particular ad in an ad campaign has been presented to the user, and so forth.

In one more embodiments, the tracking of users across multiple devices by user tracking module 124 is performed only after receiving user consent to do so. This user consent can be an opt-in consent, where the user takes an affirmative action to request that the tracking be performed before user tracking module 124 performs any tracking of that user. Alternatively, this user consent can be an opt-out consent, where the user takes an affirmative action to request that the tracking of that user not be performed by user tracking module 124. If the user does not choose to opt out of this tracking, then it is an implied consent by the user to perform the tracking.

Furthermore, it should be noted that the tracking of users across multiple devices by user tracking module 124 can allow service 102 to distinguish between different users, but need not include any personal information identifying particular users. For example, a user or user's device may log in to service 102 with a particular user name or identity, but no association between that user name and the actual person need be maintained. Accordingly, service 102 can track information regarding ads that are being served to consumer devices 104 being used by the user with that particular user name, and at the same time have no knowledge of who that user actually is.

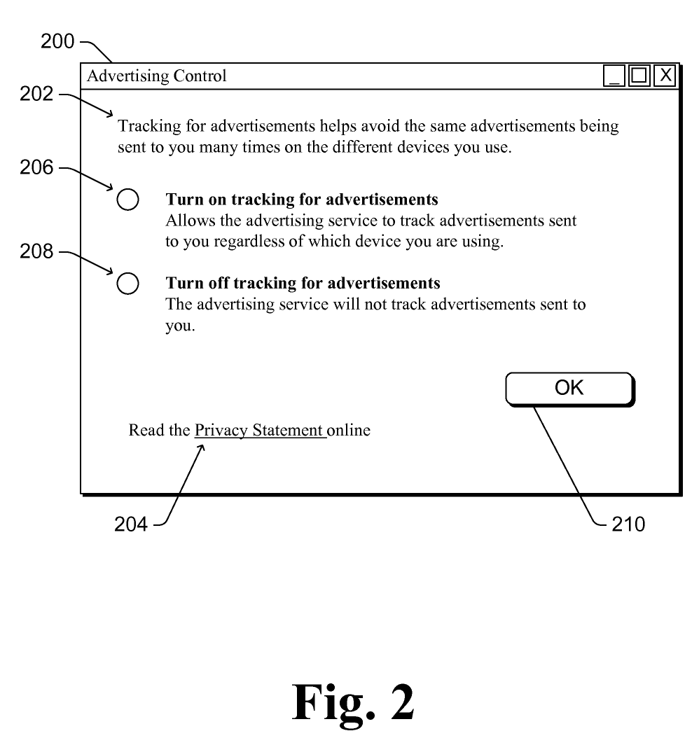

FIG. 2 illustrates an example user interface that can be displayed to a user to allow the user to select whether user tracking module 124 will track the user across multiple devices in accordance with one or more embodiments. An advertising control window 200 is displayed including a description 202 explaining to the user why platform specific ad decision service 102 is performing the tracking. A link 204 to a privacy statement is also displayed. If the user selects link 204, a privacy statement of service 102 is displayed, explaining to the user how the user's information is kept confidential.

Additionally, the user is able to select a radio button 206 to opt-in to the tracking, or a radio button 208 to opt-out of the tracking. Once a radio button 206 or 208 is selected, the user can select an “OK” button 210 to have the selection saved. It is to be appreciated that radio buttons and an “OK” button are only examples of user interfaces that can be presented to a user to opt-in or opt-out of the tracking, and that a variety of other conventional user interface techniques can alternatively be used. Tracking module 124 then proceeds to track or not track the user in accordance with the user's selection.

Returning to FIG. 1, user tracking module 124 can also allow a user to access the tracking information stored in user database 126. This allows each user that desires to do so to obtain the information in database 126 regarding that user. The user can then review the information, and can also request that the information be deleted from user database 126. Accordingly, after opting in to the user tracking, the user can subsequently opt out of the user tracking and have his or her tracking information removed from database 126.

Platform rules database 128 maintains one or more platform rules that each identify one or more restrictions on serving ads to a platform. Different consumer devices 104 can be different platforms, and one or more platform rules corresponding to each of these platforms is maintained in database 128. Each platform rule can be a variety of different restrictions on serving ads to the corresponding platform. These restrictions can be restrictions on sizes of ads, locations of ads on a display, a quantity of ads that can be displayed concurrently, a length or duration of ads that are displayed, a quantity of ads that can be displayed over a particular amount of time, volume levels of ads, and so forth.

For example, a restriction on the quantity of ads for one platform can indicate that no more than two ads can be displayed concurrently on that platform, while a restriction on the quantity of ads for another platform can indicate that no more than five ads can be displayed concurrently on that other platform. By way of another example, a restriction on the quantity of ads for one platform can indicate that no more than two ads can be displayed sequentially (e.g., before or in between segments of content) on that platform, while a restriction on the quantity of ads for another platform can indicate that no more than five ads can be displayed sequentially on that other platform. By way of another example, a restriction on the quantity of ads over a particular amount of time for one platform can indicate that two ads every 15 minutes are allowed to be displayed, while a restriction on the quantity of ads over a particular amount of time for another platform can indicate that two ads 30 minutes are allowed to be displayed. By way of yet another example, a restriction on a length of ads for one platform can indicate that 10-second ads can be played back, while a restriction on a length of ads for another platform can indicate that 30-second ads can be played back.

The platform rules stored in database 128 are received by platform specific ad decision service 102 as platform rules 140. These platform rules 140 can be received from a variety of different components, devices, services, and so forth. In one or more embodiments, platform rules 140 are received from a provider or seller of a particular platform. For example, a provider or seller of a particular type of consumer device 104 can provide platform rules 140 for that particular platform (that particular type of consumer device). By way of another example, a provider of or seller of access to a particular communication channel can provide platform rules 140 for that that particular platform (that particular communication channel).

Content information 142 is also received by platform specific ad decision service 102. Content information 142 identifies the particular digital content that is being transmitted to consumer devices 104 at various times for playback by devices 104. This content can be a variety of different types of audio and/or video content that can be played back by devices 104. For example, this content can be movies, documentaries, sitcoms, other television programs, other on-demand or previously recorded programs, and so forth. Content information 142 can be received from a variety of different components, devices, services, and so forth. In one or more embodiments, content information 142 is received from a provider or distributor of the content. For example, a provider of a particular television program or movie can provide the content information 142 for that particular television program or movie to service 102.

Ad campaign database 130 maintains information describing ad campaigns that are to be served to consumer devices 104. An ad campaign refers to one or more ads that an advertiser desires to have served to consumer devices. The ad campaign can also include characteristics of one or more ads in the ad campaign, such as the duration of an ad, a screen resolution of an ad, a volume level of an ad, and so forth. An ad campaign can optionally be a sequence of ads that the advertiser desires to have served to users of the consumer devices in a particular sequence. For example, the advertiser may have a sequence of three ads, and identify as part of the ad campaign a first of the three ads that is to be served prior to the other two ads, a second of the three ads that is to be served after the first ad but before the third ad, and the third of the three ads that is to be served after the other two ads. Additionally, an ad campaign can specify additional limits or restrictions on the serving of ads, such as how many times a particular ad is to be played back to a user. For example, the ad campaign can specify that a particular ad is to be played back to a user no more than three times.

For each ad campaign, database 130 can also identify content associated with the ad campaign that is the particular content during which the ads in the ad campaign are to be served. These ads can be served to the consumer devices for playback concurrent with and/or interspersed with the content. Ad campaign database 130 can also optionally store the particular ads or alternatively can store identifiers of the particular ads. If database 130 stores identifiers of the particular ads in the ad campaign, then ad control module 122 can access another component or device to obtain the identified ads when those ads are to be served to the consumer devices, or alternatively module 122 can notify another component or device to serve the identified ads to the consumer devices at the appropriate times.

For each ad campaign, database 130 can also optionally identify different versions of ads, and these different versions can be treated by service 102 as different ads. For example, an advertiser can prepare multiple different versions of an ad having different characteristics, such as different screen resolutions, different durations, different volume levels, and so forth. This information can be stored in ad campaign database 130, and can be used in conjunction with platform rules for a particular consumer device to identify the particular ad to be served to that particular consumer device as discussed in more detail below.

The ad campaign information stored in database 130 is received as ad campaign information 144. This ad campaign information 144 can be received from a variety of different components, devices, services, and so forth. In one or more embodiments, ad campaign information 144 is received from a provider or distributor of the ads (e.g., the advertiser). For example, a particular advertiser can provide the ad campaign information 144 for a particular set of ads to service 102.

Ad control module 122 determines when an ad is to be served to a consumer device 104 as well as what ad is to be served to a consumer device 104 based on various criteria as discussed in more detail below. Ad control module 122 can determine when an ad is to be served to a consumer device 104 in a variety of different manners, such as based on particular rules or criteria maintained by module 122, based on restrictions in platform rules 140, based on indications included in content information 142 of when ads are to be served, based on indications included in ad campaign information 144 of when ads are to be served, based on a request to serve an ad received from another component or module, and so forth. For example, a restriction on a quantity of ads over a particular amount of time that can be displayed on a platform can be used to identify how many ads are served to a particular platform, and an indication in content information 142 can be used to identify particular times during playback of content that the ads are to be displayed.

Ad control module 122 determines the particular ad to be served to a particular consumer device 104 based at least in part on one or more of the particular platform of that consumer device, the platform rules in database 128 corresponding to that platform, the particular content being played back on a consumer device, and the ad campaign information in database 130. As discussed above, ad campaign database 130 identifies a particular ad campaign associated with particular content. Ad control module 122 obtains information identifying the particular content being played back on a particular consumer device 104. This information identifying the particular content can be obtained from a variety of different sources, such as the provider of the content, the consumer device 104 itself, and so forth. Ad control module 122 uses this information identifying the particular content being played back to identify a corresponding ad campaign in ad campaign database 130. Alternatively, an ad campaign in ad campaign database 130 can be a generic ad campaign associated with multiple different (e.g., all) content. Accordingly, the ad campaign can be identified independently of the particular content being played back.

Ad control module 122 also obtains an indication of the particular platform on which the content is being played back. This indication of the particular platform can be obtained from a variety of different sources, such as the provider of the content, the consumer device 104 itself, and so forth. Ad control module 122 uses this indication of the platform to identify one or more platform rules for that platform as stored in platform rules database 128. Ad control module 122 thus has access to the appropriate ad campaign and the appropriate platform rules for the consumer device that is to be served one or more ads.

Ad control module 122 compares the platform rules to the ads in the ad campaign in order to identify the appropriate one or more ads to be served to the consumer device. The platform rules identify restrictions on ads from the ad campaign that can be served on the platform of the consumer device. One or more ads from the ad campaign are thus selected that satisfy these restrictions. In situations where there are more ads in the ad campaign that satisfy these restrictions than are to be served to the consumer device at the present time, a subset of these ads that satisfy the restrictions is selected. This subset of ads can be identified in a variety of different manners, such as based on criteria stored with the ad campaign itself, randomly, based on input from another component or module, according to other rules or criteria of module 122, and so forth.

Additionally, as discussed above user tracking module 124 tracks particular users across different devices 104 and stores information in user database 126 to facilitate this tracking. In one or more embodiments, ad control module 122 leverages this information in user database 126 in identifying the appropriate one or more ads to be served to the consumer device. The current user of a consumer device 104 to which an ad is to be served is tracked by module 124 as discussed above. Ad control module 122 obtains an identifier of the current user of consumer device 104 from user tracking module 124. Information describing ads in the ad campaign that is to be presented to the user is maintained by module 122 in user database 126. This information can include indications of ads that have already been presented to the user or are still to be presented to the user (e.g., identifiers of individual ads, an identifier of a location in the sequence, and so forth), counts of how many times an ad is to be presented to the user and how many time the ad has been presented to the user, and so forth.

In one or more embodiments, after an ad has been played back by the consumer device, the consumer device returns a notification that the ad was played back to platform specific ad decision service 102. Ad control module 122 can update user database 126 accordingly, indicating that the particular ad has been played back to the user. Alternatively, rather than maintaining information in database 126 regarding the ads that are played back, information regarding the ads that are served to the consumer devices can be maintained in database 126. In such situations, a notification that the ad was played back need not be returned by the consumer device to service 102.

For example, as discussed above an ad campaign can be a sequence of ads that the advertiser desires to be presented to a user of consumer devices 104 in a particular sequence. When identifying a particular one or more ads in the sequence of ads to be served to a consumer device 104, ad control module 122 accesses user database 126 to identify which ad or ads in the sequence have already been presented to that user. Based on the information regarding the ad campaign in database 130, ad control module 122 can readily identify the next ad or ads in the sequence that are to be served to that user.

By way of another example, as discussed above an ad campaign can indicate that a particular ad is to be presented to the user a particular quantity of times. When identifying a particular one or more ads in the ad campaign to be served to a consumer device 104, ad control module 122 accesses user database 126 to identify how many times the particular ad has already been presented to that user. Based on the information regarding the ad campaign in database 130, ad control module 122 can readily identify whether that particular ad is to be presented to the user again or whether a different ad is to be presented to the user.

It should be noted that in such situations where the user is being tracked, the user is tracked across the multiple consumer devices 104, thereby allowing the user to continue in the ad campaign regardless of the particular consumer device 104 that he or she is using at any particular time. However, it should also be noted that the platform of the consumer device can still be a factor in determining the particular ad that is to be served to the consumer device. The platform rules discussed above are still satisfied by module 122 based on the platform to which the ad is served.

Furthermore, it should also be noted that as discussed above this user tracking can optionally be performed only after receiving user consent to do so. Accordingly, if a user desires to not be tracked, then he or she can simply choose to not be tracked in which case this tracking by user tracking module 124 will not be performed for that user.

Additionally, it should also be noted that an ad can be played back by a consumer device 104 while the ad is being served to the consumer device, such as playing back the ad while the ad is being streamed to the device. Alternatively, the ad can be served to the consumer device an amount of time (e.g., 30 seconds, five minutes, etc.) prior to the ad being played back by the consumer device.

As discussed above, a notification that an ad was played back can be returned to platform specific ad decision service 102. Service 102 can track these notifications to maintain a record of which ads from an ad campaign has actually been played back by users. This record can optionally be returned to advertisers to provide a report on their ad campaigns. The different ads served to the consumer devices 104 can include identifiers to facilitate this notification and tracking. It should be noted that this tracking is a tracking of ads that have been played back, and information identifying the user to which the ad was played back and/or the consumer device 104 on which the ad was played back need not be collected or maintained.

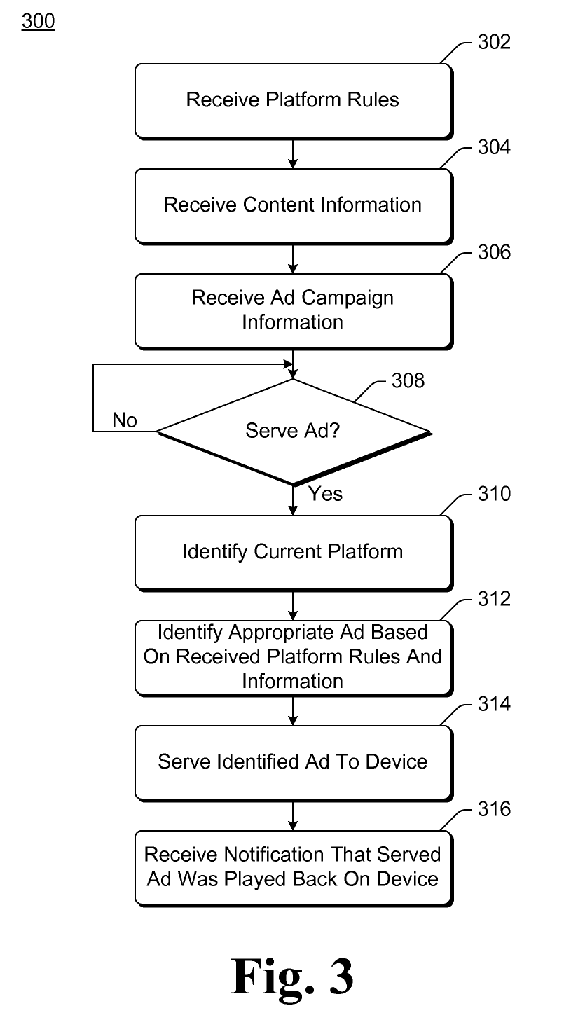

FIG. 3 is a flowchart illustrating an example process 300 for identifying an ad to serve to a device in accordance with one or more embodiments. Process 300 is carried out by a platform specific ad decision service, such as service 102 of FIG. 1, and can be implemented in software, firmware, hardware, or combinations thereof. Process 300 is an example process for identifying an ad to serve to a device; additional discussions of identifying an ad to serve to a device are included herein with reference to different figures.

In process 300, platform rules are received (acts 302). As discussed above, one or more platform rules can be received for each of multiple different platforms.

Content information is also received (acts 304). As discussed above, information describing the various content that can be played back on the consumer devices is received.

Ad campaign information is also received (acts 306). The ad campaign information identifies one or more ads to be served to consumer devices playing back particular content as discussed above.

Process 300 then waits until it is time to serve an ad to a consumer device (act 308). The determination of when it is time to serve an ad to the consumer device can be based on a variety of factors as discussed above, including the platform rules received in act 302. It is to be appreciated that additional platform rules, contact information, and ad campaign information can be received while process 300 is waiting.

When it is time to serve an ad to a consumer device, the current platform via which content is being played back is identified (act 310). This current platform can be identified in different manners, such as being determined automatically based on the communication channel used to communicate with the consumer device, an indication of the current platform received from the consumer device or alternatively from another component or device, and so forth.

Additionally, an appropriate ad based on the received platform rules for the current platform as well as the received ad campaign information and optionally the received content information is identified (act 312). Such an appropriate ad is an ad that satisfies the platform rules for the current platform as well as the received ad campaign information (and optionally the received content information). This identified ad is then served to the consumer device (act 314) for playback at the consumer device.

Furthermore, a notification that the served ad was played back on the consumer device can optionally be received from the consumer device after the ad is played back (act 316).

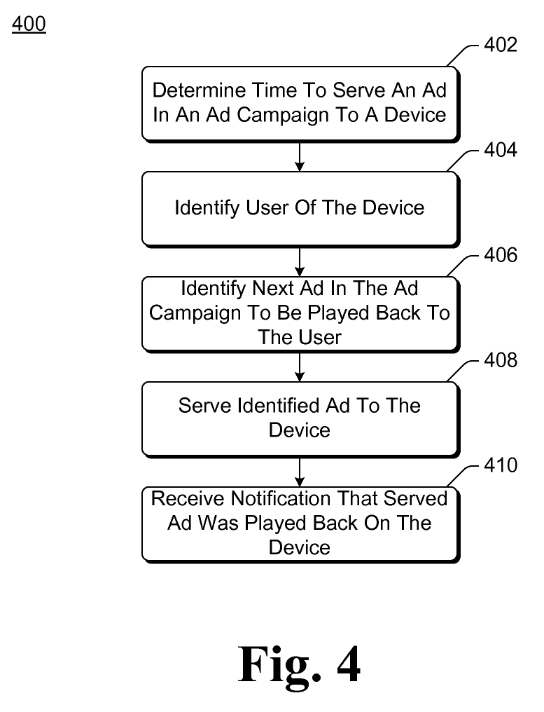

FIG. 4 is a flowchart illustrating another example process 400 for identifying an ad to serve to a device in accordance with one or more embodiments. Process 400 is carried out by a platform specific ad decision service, such as service 102 of FIG. 1, and can be implemented in software, firmware, hardware, or combinations thereof. Process 400 is an example process for identifying an ad to serve to a device; additional discussions of identifying an ad to serve to a device are included herein with reference to different figures.

In process 400, a time to serve an ad in an ad campaign to a consumer device is determined (act 402). This determination can be made in a variety of different manners as discussed above.

The particular user of the consumer device to which the ad is to be served is identified (act 404). This identification of the user can be performed in a variety of different manners as discussed above.

A next ad in the ad campaign to be played back is identified (act 406). As discussed above, the platform specific ad decision service can track the user across multiple consumer devices and thus can identify the next ad in the ad campaign to be played back for the user regardless of the consumer device or devices on which previous ads in the campaign were played back. Also as discussed above, this ad campaign can include an ad sequence, can specify limits on how many times a particular ad in the ad campaign is to be presented to the user, and so forth.

The identified ad is then served to the consumer device being used by the user (act 408) for playback at the consumer device. Additionally, a notification that the served ad was played back on the consumer device can optionally be received from the consumer device after the ad is played back (act 410).

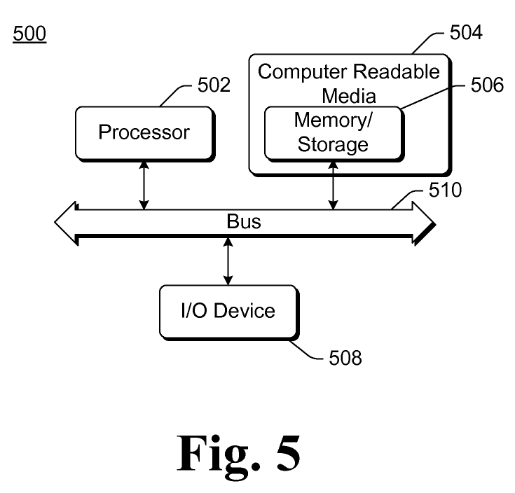

FIG. 5 illustrates an example computing device 500 that can be configured to implement the platform or user sensitive advertising in accordance with one or more embodiments. Computing device 500 can be, for example, a consumer device 104 of FIG. 1, or can implement a platform specific ad decision service 102 of FIG. 1.

Computing device 500 includes one or more processors or processing units 502, one or more computer readable media 504 which can include one or more memory and/or storage components 506, one or more input/output (I/O) devices 508, and a bus 510 that allows the various components and devices to communicate with one another. Computer readable media 504 and/or one or more I/O devices 508 can be included as part of, or alternatively may be coupled to, computing device 500. Bus 510 represents one or more of several types of bus structures, including a memory bus or memory controller, a peripheral bus, an accelerated graphics port, a processor or local bus, and so forth using a variety of different bus architectures. Bus 510 can include wired and/or wireless buses.

Memory/storage component 506 represents one or more computer storage media. Component 506 can include volatile media (such as random access memory (RAM)) and/or nonvolatile media (such as read only memory (ROM), Flash memory, optical disks, magnetic disks, and so forth). Component 506 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 502. It is to be appreciated that different instructions can be stored in different components of computing device 500, such as in a processing unit 502, in various cache memories of a processing unit 502, in other cache memories of device 500 (not shown), on other computer readable media, and so forth. Additionally, it is to be appreciated that the location where instructions are stored in computing device 500 can change over time.

One or more input/output devices 508 allow a user to enter commands and information to computing device 500, and also allow information to be presented to the user and/or other components or devices. Examples of input devices include a keyboard, a cursor control device (e.g., a mouse), a microphone, a scanner, a remote control, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 5. The features of the platform or user sensitive advertising techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1 A method implemented in a service, the method comprising:
receiving, for each of multiple different platforms, one or more platform rules identifying one or more restrictions on serving ads to the platform;
receiving information describing both an ad campaign and content to which the ad campaign corresponds;
identifying a current platform via which content is currently being played back; and
identifying an appropriate ad from the ad campaign to be served to the current platform, the identifying of the appropriate ad being based at least in part on the ad campaign and the one or more platform rules for the current platform.

2. A method as recited in claim 1, wherein the one or more restrictions comprises a restriction on a quantity of ads that can be concurrently displayed by the platform.

3. A method as recited in claim 1, wherein the one or more restrictions comprises a restriction on locations where ads can be displayed on a display device.

4. A method as recited in claim 1, wherein the one or more restrictions comprises a restriction on a duration of ads that can be played back by the platform.

5. A method as recited in claim 1, wherein the ad campaign comprises a sequence of ads, wherein one or more ads in the sequence of ads have already been played back by one or more consumer devices used by a user of the current platform, and the identifying is further based at least in part on the one or more ads in the sequence of ads that have already been played back.

6. A method as recited in claim 5, wherein the one or more consumer devices comprise multiple different platforms used by the user.

7. A method as recited in claim 1, wherein the receiving one or more platform rules comprises receiving a first one or more platform rules for a wireless phone platform, and receiving a second one or more rules for a set-top box platform.

8. A method as recited in claim 1, wherein the multiple different platforms comprise different types of devices.

9. A method as recited in claim 1, wherein the multiple different platforms comprise different communication channels for a same type of device.

10. A method as recited in claim 1, further comprising determining, based at least in part on the one or more platform rules for the current platform, when the appropriate ad is to be served to the current platform.

11. A method as recited in claim 1, further comprising:
serving the appropriate ad to the current platform;
receiving, from the current platform, a notification that the appropriate ad has been played back; and
maintaining a record that the appropriate ad has been played back.

12. A method as recited in claim 1, wherein the identifying is further based at least in part on the content currently being played back.

13. A method comprising:
determining a time that an ad in an ad campaign is to be served to a device;
identifying a user of the device;
identifying, based at least in part on one or more ads in the ad campaign that have previously been played back by one or more devices regardless of which of the one or more devices were being used by the user while playing back the one or more ads, a next ad in the ad campaign that is to be played back; and
serving the identified ad to the device.

14. A method as recited in claim 13, wherein the ad campaign comprises a sequence of ads that are to be played back in a sequence, and the identifying a next ad comprises identifying the next ad based at least in part on which ads in the sequence of ads have already been played back by the device.

15. A method as recited in claim 13, further comprising receiving, from the device, a notification that the identified ad has been played back.

16. A method as recited in claim 15, wherein the ad campaign includes an indication of a quantity of times a particular ad of the one or more ads is to be played back, and the identifying a next ad comprises identifying the next ad based at least in part on whether the particular ad has already been played back the quantity of times.

17. A method as recited in claim 13, wherein a current platform of the device is based at least in part on a type of the device, and wherein identifying the next ad further comprises identifying the next ad based at least in part on the current platform of the device and one or more platform rules for the current platform.

18. A method as recited in claim 17, wherein the current platform of the device is further based on a type of communication channel used by the device.

19. A method as recited in claim 17, wherein the determining the time that an ad in an ad campaign is to be served to a device is based at least in part on the one or more platform rules for the current platform.

20. One or more computer storage media having stored thereon multiple instructions that, when executed by one or more processors, cause the one or more processors to:
receive, for each of multiple different platforms, one or more platform rules identifying one or more restrictions on serving ads to the platform;
receive information describing both an ad campaign and content to which the ad campaign corresponds;
identify a current platform via which content is currently being played back;
identify a next ad from the ad campaign to be served to the current platform, wherein to identify the next ad is to identify the next ad based at least in part on the ad campaign, the content currently being played back, the one or more platform rules for the current platform, and one or more ads in the ad campaign that have previously been played back via one or more platforms regardless of which of the one or more platforms were being used by a user while playing back the one or more ads; and
serve the identified next ad to the device.
